(19) United States
(12) Patent Application Publication
(10) Pub. No.: US 2005/0028679 A1
(43) Pub. Date: Feb. 10, 2005

(54) Method and device for the sterilization of wine utilizing focused electrical fields

(76) Inventor: Richard Williamson, Napa, CA (US)

Correspondence Address: RICHARD WILLIAMSON, 1217 SPROUL AVENUE, NAPA, CA, 94559, US

(21) Appl. No.: 10/634,969

(22) Filed: Aug. 5, 2003

(51) Int. Cl. A23L 3/28

(52) U.S. Cl. 99/451; 422/208

(57) ABSTRACT

An improved method and apparatus for sterilization of wine and other edible fluids utilizing concentrated and focused steady-state electrical fields (18) generated by a series of specially shaped charged electrodes (12)(20)(24). Apparatus incorporates a fluid passage duct (14) constructed of strong dielectric material situated between said charged electrodes. Said apparatus necessarily includes appurtenances to the apparatus to facilitate conveyance of fluid into and out of said fluid passage duct. Said apparatus necessarily includes electrical circuitry (16) to maintain a steady-state electrical charge on the aforementioned specially shaped electrodes (12)(20)(24).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to the processes of producing fermented beverages from grapes for human consumption and the equipment employed in said processes. These processes taken together are generally referred to as winemaking. Further, this invention relates to the essential winemaking concern for controlling microorganism populations in all steps of producing the wine, both unfinished and finished. Further again, this invention relates to controlling said microorganism populations using concentrated and focused electric fields generated by specially shaped and continuously charged electrodes.

### BACKGROUND OF THE INVENTION

Throughout the multi-step process of producing finished fermented drinks such as wine, necessary steps are taken to protect against infection from and elimination of infection by bacteria, yeasts, fungi and spores. Oftentimes these steps are detrimental to the quality of the finished products and are taken only out of necessity. Presently used detrimental steps in the production of these beverages for sterilization purposes include pasteurization, ultrafiltration, and chemical additions.

This invention provides an entirely new alternative to these sterilization steps which respects the organoleptic aspects of the wine. A simple and economic means is described herein for complete elimination of bacteria, yeast, fungi, and spores in the fermented beverage, thereby increasing the quality and the shelf life of the finished product.

The fact is well established in the prior art, literature and practice that the exposure of a solution containing living microorganisms to a strong electric field will cause the breakdown and destruction of those microorganisms. This invention, which unlike the prior art, produces very focused electrical fields, takes advantage of the well established fact that the strength or concentration of the electric field is the most significant factor in the effectiveness of the killing of the microorganisms, as opposed to the duration of exposure or any other factor.

It is further well established in scientific and academic literature that it is possible to effect a focusing and concentration of an electric field by employing electrodes with a sharp edge or convex edge. These concepts taken together are the basis of this invention.

### BACKGROUND OF THE INVENTION—PRIOR ART

Sterilization of various fluid food products has been contemplated, tested and commercially attempted using both pulsed electric fields and continuous electric fields.

Pulsed electric field equipment is not economical for commercial use. The technology has been known for many years and has not become commercially viable for this reason.

Sterilization of fluid food products has been attempted using a continuous electrical field. Prior art of this type has not contemplated the use of strategically shaped electrodes to obtain a concentration and focusing of the electrical field. Economic and efficacy gains from focusing and concentrating of the electrical field have not been obtained prior to this current invention. Secondly, the prior art contemplates utilizing a highly charged electrode in direct contact with the product to be sterilized. This will cause a dead short through wine, thus requiring some unknown form of electrical circuitry to limit current while maintaining a high potential difference.

The prior art does not contemplate the use of either of the above described inferior general approaches for the production of wine.

### BACKGROUND OF THE INVENTION—OBJECTS AND ADVANTAGES

The object of this invention is to provide the winemaker with a superior means to control the quality of finished wine by eliminating unwanted microorganisms in the wine while completely respecting the sensory aspects of the wine.

A second object of this invention is to provide a means for wine sterilization that is actually functional, economically feasible for purchase and operation by a commercial winery.

The advantages of using concentrated and focused electrical fields for wine sterilization purposes over an unfocused electric field are distinct. The threshold field strength required for effective microbe kill is best obtained by focusing and concentrating as is described in this current invention. The electric field can be substantially strengthened with much more economical equipment. Lower voltages can be used to obtain a more satisfactory result over an unfocused method, thus making the equipment safer to operate.

Electrical isolation of the electrodes from the wine allows the generation of an extremely strong electrical field without allowing the passage of any current through the wine. This has the advantage of being electrically simple and overcomes the problem of the electrical circuit shorting out through the wine.

Further objects and advantages will become apparent from a consideration of the drawings and ensuing description.

### SUMMARY OF THE INVENTION

This invention is an innovative device to sterilize wine and wine in process. The wine is passed through an electrically insulating sleeve between a succession of pairs of specially shaped electrodes. These electrodes have a continuous high voltage across them, which creates a continuous electric field between them and thus through the wine.

The special shape of the electrodes; pointed, sharp, wire, or sharply convex, causes the electrical field to be focused and concentrated near the points.

The microorganisms present in the wine are exposed to this concentrated electrical field and killed by it.

The wine is insulated from the electrodes by a sleeve made from a strong dielectric material, such as teflon.

### BRIEF DESCRIPTION OF THE DRAWINGS

FIG. 1—Treatment Chamber, top view

This drawing shows the general arrangement of the shaped electrodes in relationship to the sleeve carrying the wine to be sterilized. Also shown is the electrical circuit to provide the potential difference between the electrodes.

FIG. 2—Treatment Chamber, side view

This drawing shows the general arrangement of the shaped electrodes in relationship to the sleeve carrying the wine to be sterilized. Also shown is the electrical circuit to provide the potential difference between the electrodes.

FIGS. 3A & 3B—Electrical Field Concentration

These two drawings taken together demonstrate the focusing and concentration of an electrical field near a sharply shaped or convex charged electrode.

FIG. 4—Treatment Chamber, top view, additional embodiment

This drawing shows a treatment chamber with shaped electrodes placed at both poles of the electrical charge.

FIG. 5—Treatment Chamber, top view, alternate embodiment

This drawing shows a treatment chamber with shaped electrodes constructed from fine conductive wires placed at both poles of the electrical charge.

FIG. 6—Treatment Chamber, top view, additional embodiment

This drawing shows a treatment chamber with shaped electrodes constructed from foil or thin sheet metal placed at both poles of the electrical charge.

### DRAWINGS—REFERENCE NUMERALS

10—flat electrode
12—shaped electrode
14—fluid passage duct
16—power circuit
18—electrical field
20—wire electrode
22—wire electrode holder
24—foil or thin sheet metal electrode
26—foil electrode holder

### DETAILED DESCRIPTION—PREFERRED EMBODIMENT

The current invention provides a treatment chamber design which provides a safe and economical method to generate strong concentration and focusing of an electrical field and the means to pass wine through said field for the purpose of killing harmful microorganisms within the wine.

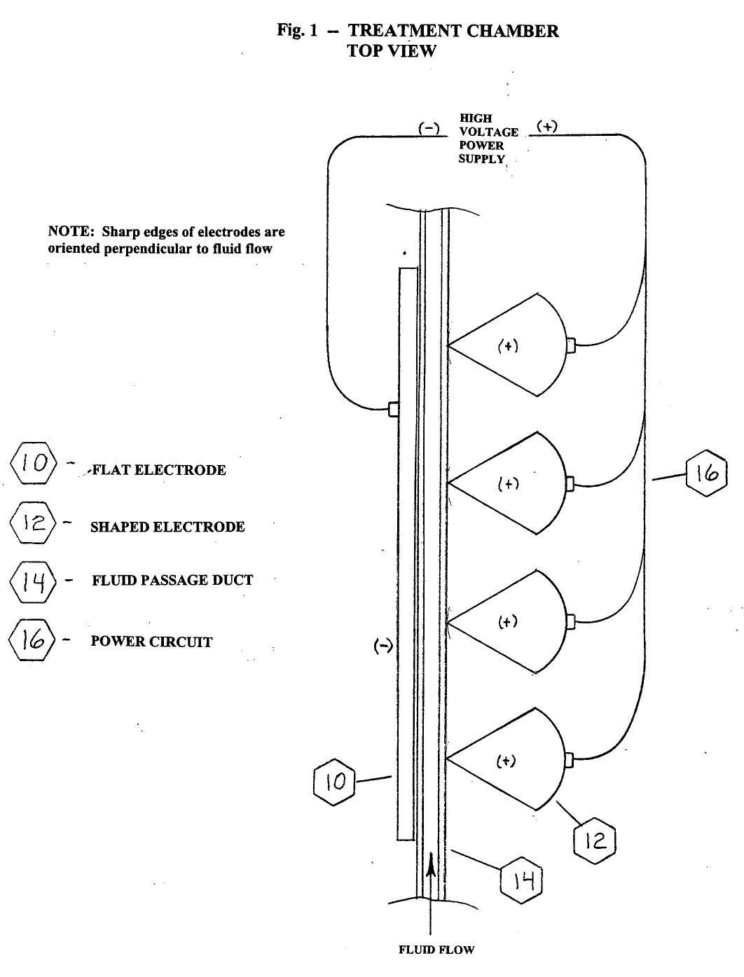

Electrical field concentration is achieved by providing an electrical potential across an opposing pair of flat or strategically shaped electrodes. The preferred embodiment of this invention as shown in top view in FIG. 1—Treatment Chamber, shows clearly the arrangement of a series of sharply or convex shaped electrodes (part number 12) paired with a flat electrode (part number 10).

Placed between these electrodes is a flatly rectangular shaped fluid passage duct (part number 14) which allows passage of the wine between the pairs of electrodes while providing electrical isolation from the electrodes. The fluid passage duct is constructed of a dielectric material, the most effective material being teflon. It is at the points along the fluid passage duct where the points of the shaped electrodes approach the fluid passage duct that the electrical field is focused.

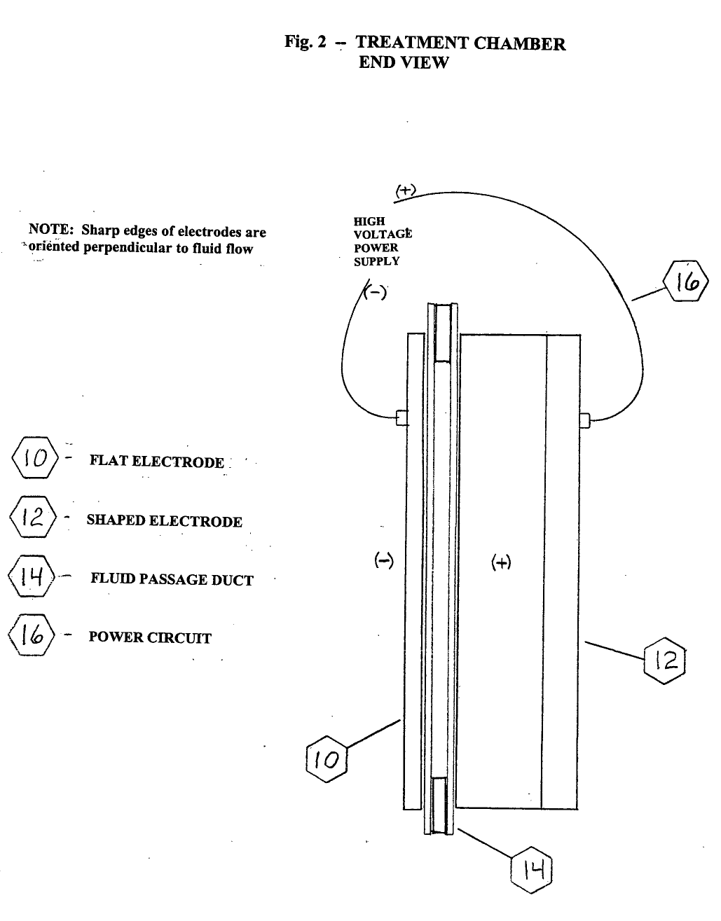

FIG. 1 and FIG. 2 which taken together give a clear representation of the geometries and relationships of all of the critical parts of this invention, both also show the circuitry required to impart a steady state electrical potential across the opposing sets of electrodes.

The current invention is shown in section view through the treatment chamber in FIG. 2—Treatment Chamber. This view of the current invention shows the relationships both geometrically and electrically between the flat electrode (part number 10), the shaped electrodes (part number 12), the power circuitry (part number 16), and the fluid passage duct (part number 14). It is shown in this view of the invention that the wine when passed through the fluid passage duct is exposed in it's entirety to the concentrated electrical field existent between the opposing charged electrodes.

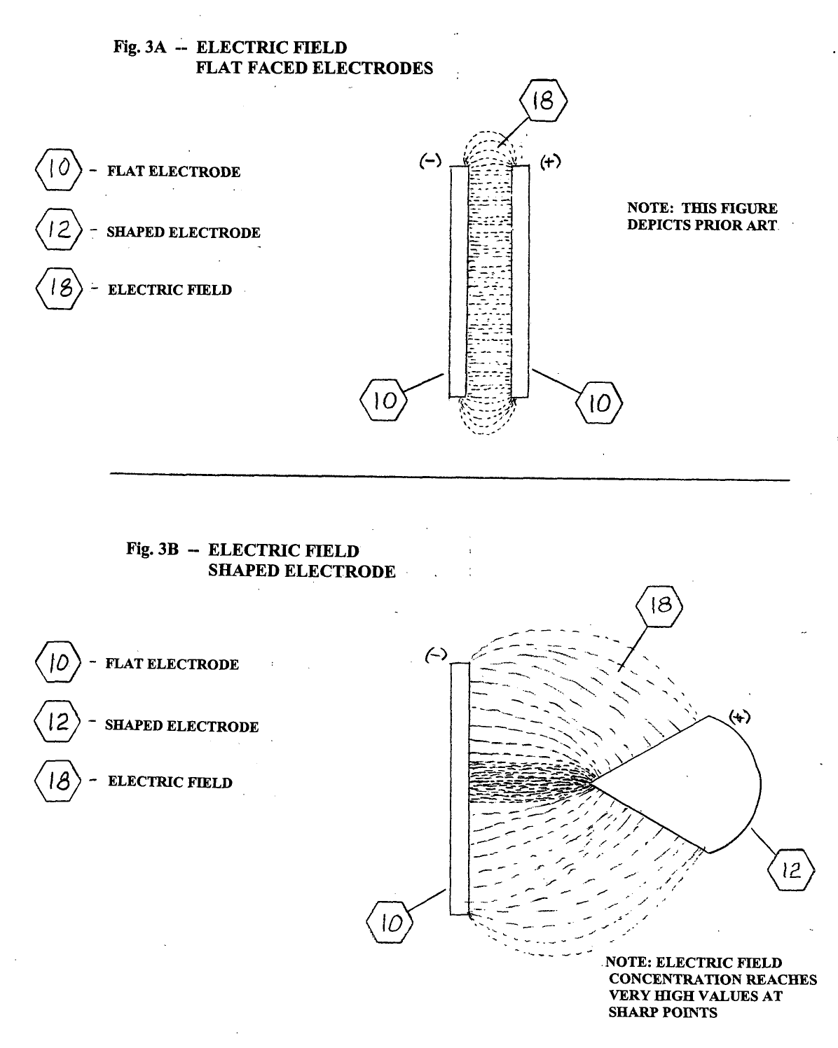

FIG. 3A—Electric Field, Flat Faced Electrodes shows the nature of an electrical field (item number 18) that is generated between a pair of charged electrodes without the effect of field concentration and focusing. This type of graphical representation of an electrical field between two flat charged electrodes (part number 10) is universally shown in physics textbooks. This figure shows the configuration of the electrical field that is generated in the prior art and is not the configuration employed in the current invention. This figure is presented here to clarify the contrast between the prior art and the current invention. A note is placed on FIG. 3A stating that this figure depicts the prior art.

FIG. 3B—Electric Field, Shaped Electrodes shows the configuration of an electrical field (item number 18) in the immediate vicinity of a shaped electrode (part number 12). Note that the field is concentrated and focused at the point of the shaped electrode. This provides this invention with a zone of very strong electrical field. This type of graphical representation of electrical field concentration in the immediate vicinity of a charged sharp electrode is commonly shown in physics textbooks. Generation of a concentrated and focused electrical field in this way is an almost standard lab exercise in a college level course in electricity and magnetism. Field concentration in this manner is routinely developed on top of an overhead projector in the classroom using shaped electrodes in a bath of dielectric oil with tiny fibers of silk in the oil. The fibers suspended in the oil take the shape of the field as shown in FIG. 3B. This technique displays the field configuration and allows the shape of the field to be photographed.

### OPERATION—PREFERRED EMBODIMENT

The operation of the treatment chamber is aimed toward passing the wine through the fluid passage duct in a controlled manner to repeatedly expose the wine to a focused and concentrated electrical field of sufficient strength to kill the microorganisms present in the wine.

The mechanical effort imparted onto the wine to force it through the treatment chamber is provided in a typical winery by either gravity flow or by pumping. The pumping, piping, hoses, manifolds, and other appurtenances related to the movement of the wine in and through the treatment chamber is not a part of the current invention.

The flow rate of the wine is monitored with a flow meter situated either upstream or downstream of the treatment chamber. It is necessary for the operator to monitor and control the wine flow rate below a specified rate for the size of fluid duct. Fluid passage duct sizes vary according to the required flow rate. Typically this is below 10 gallons per minute, although large wineries operate bottling lines which require sterilization at rates in excess of 30 gallons per minute.

The voltage and thus the electrical field strength is not variable. It is set at no less than 20,000 volts per centimeter. Variation of treatment capacity is varied by changing the size of the fluid passage duct only.

### DETAILED DESCRIPTION—ALTERNATIVE EMBODIMENT

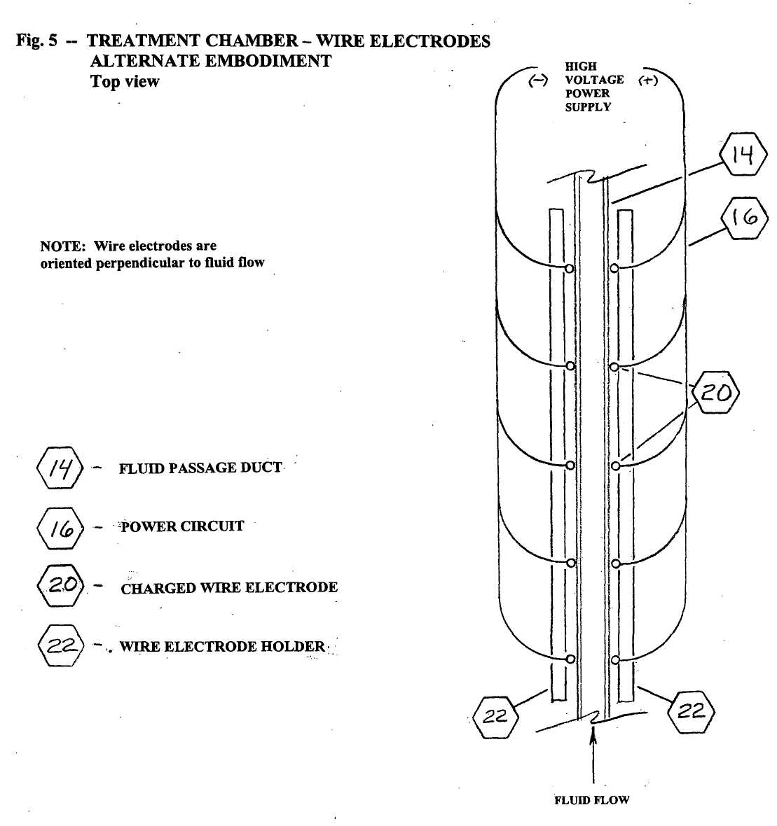

FIG. 5—Treatment Chamber, Alternate Embodiment shows opposing sets of charged electrodes (part number 20) fabricated from electrically conductive wire. These wires are oriented with the length of wire perpendicular to the fluid flow. The sharply convex surface of the wire, which faces the fluid passage duct (part number 14) focuses the electrical field through the duct and the fluid.

### OPERATION—ALTERNATIVE EMBODIMENT

The operation of the treatment chamber with wire electrodes is identical to that of the preferred embodiment. See ‘OPERATION—Preferred Embodiment’ for operating details.

### DETAILED DESCRIPTION—ADDITIONAL EMBODIMENT

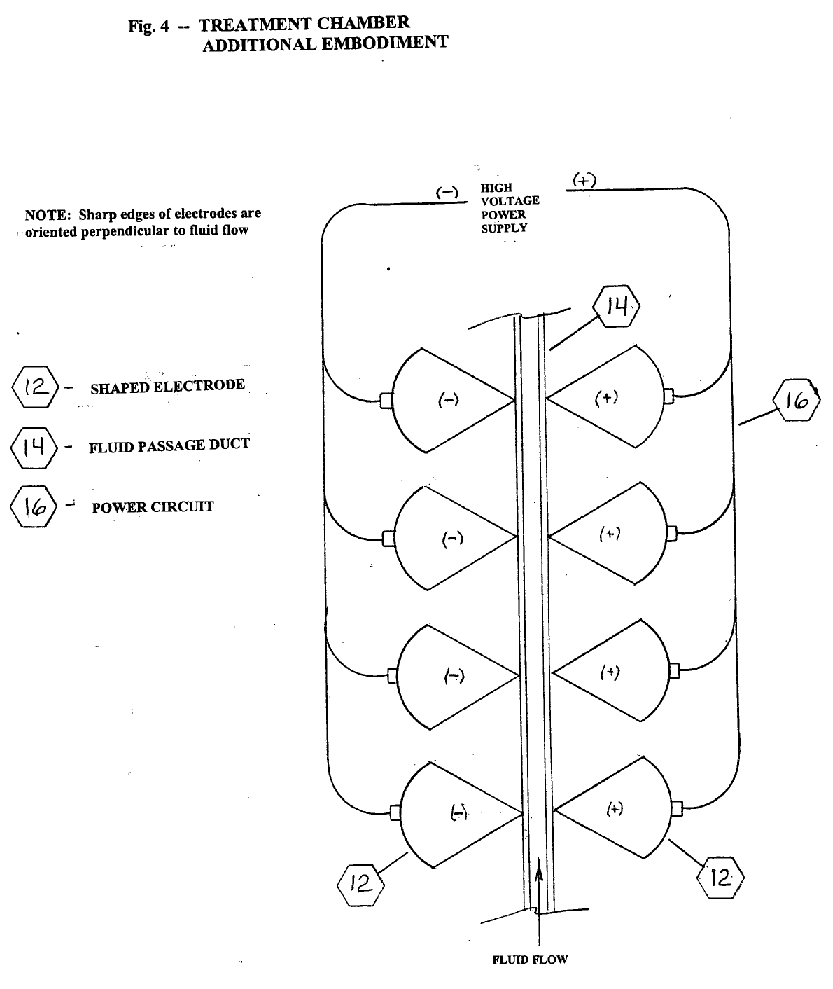

FIG. 4—Treatment Chamber, Additional Embodiment shows opposing sets of shaped electrodes (part number 12) placed on opposite sides of the fluid passage duct (part number 14). The electrical circuitry (part number 16) to provide the potential difference between the electrodes in also shown. This embodiment of the current invention provides the focusing and concentration affect from both sides of the fluid passage duct, thus enhancing the field strength within the fluid. This embodiment differs from the preferred embodiment in that the specially shaped electrodes are placed on both sides of the fluid as opposed to placing a flat electrode on one side.

### OPERATION—ADDITIONAL EMBODIMENT

The operation of the treatment chamber with opposing pairs of shaped electrodes is identical to that of the preferred embodiment. See ‘OPERATION—Preferred Embodiment’ for operating details.

### DETAILED DESCRIPTION—ADDITIONAL EMBODIMENT

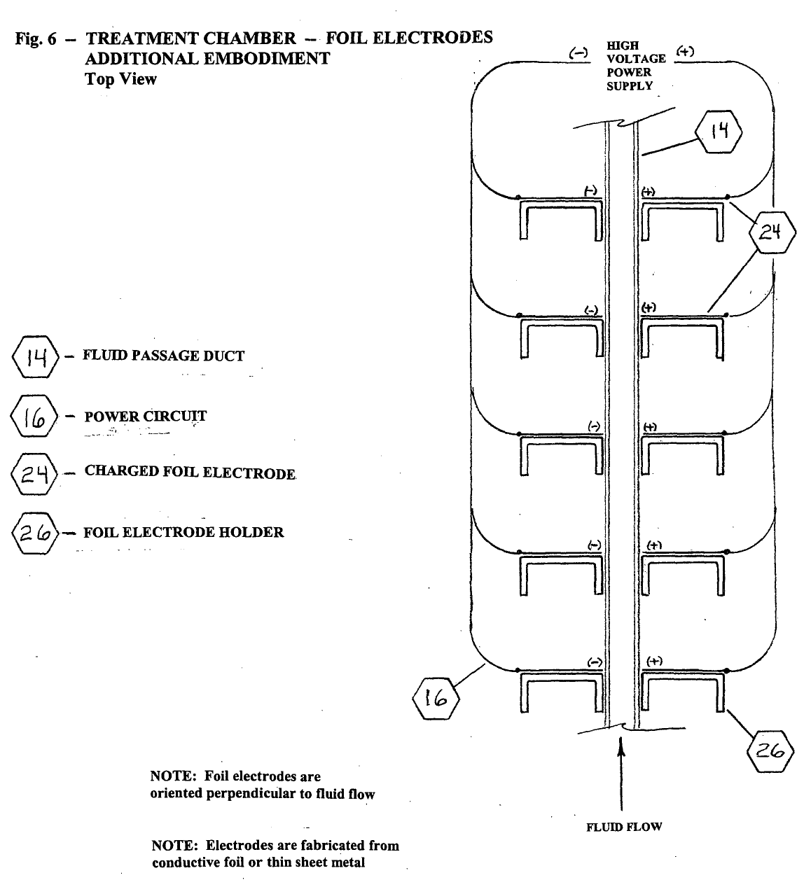

FIG. 6—Treatment Chamber, Foil Electrodes, Additional Embodiment shows opposing sets of foil or thin sheet metal electrodes (part number 24) placed on opposite sides of the fluid passage duct (part number 14). The electrical circuitry (part number 16) to provide the potential difference between the electrodes in also shown. This embodiment of the current invention provides the focusing and concentration affect from sharp edged foil or thin sheet metal on both sides of the fluid passage duct, thus enhancing the field strength within the fluid. This embodiment differs from the preferred embodiment in that the sharp edged foil electrodes are placed on both sides of the fluid as opposed to placing a flat electrode on one side.

### OPERATION—ADDITIONAL EMBODIMENT

The operation of the treatment chamber with foil or thin sheet metal electrodes is identical to that of the preferred embodiment. See ‘OPERATION—Preferred Embodiment’ for operating details.

### CONCLUSIONS, RAMIFICATIONS AND SCOPE

This current invention has distinct advantages over the prior art. First, the strength or concentration of the electrical field is well established as the controlling factor in killing of microorganisms in fluids. This invention focuses the electrical field at the sharp edge of the shaped electrodes thus obtaining a field concentration factor of up to 5 times. This advancement enhances the efficacy of the kill over the prior art to the point that this method has now become a very real practical alternative for sterilization of fluids.

The prior art does not contemplate insulation of the fluid medium from the high voltage electrode circuit, a configuration that is inherently flawed in that a dead short through the electrically conductive fluid will result. This current invention provides for a fully insulating fluid passage duct constructed from dielectric material that will prevent shorting out of the electrode circuit.

The primary ramification of this invention is that the end users have at their disposal a genuinely viable alternative for wine sterilization which completely respects the sensory aspects of the wine. Furthermore this invention has taken the entire concept of electrical field sterilization out of the realm of fond wishes and made it an actually available and efficient option.

1) An electrical field based sterilization apparatus for wine or other edible fluids utilizing a fluid passage duct constructed of electrically insulating material situated between a collection of charged electrode pairs

2) An electrical field based sterilization apparatus for wine or other edible fluids utilizing said electrodes which are sharp, wire or convex shaped to focus and concentrate said electrical field upon said fluid passage duct

3) An electrical field based sterilization apparatus for wine or other edible fluids utilizing circuitry to maintain a continuous, non-pulsing high electrical potential across said pairs of electrodes

4) An electrical field based sterilization apparatus for wine or other edible fluids utilizing fluid handling appurtenances to direct the fluid in and out of the aforementioned fluid passage duct.
